(19) United States
(12) Patent Application Publication
(10) Pub. No.: US 2003/0231344 A1
(43) Pub. Date: Dec. 18, 2003

(54) Process for validating groups of machine-read data fields

(76) Inventor: Bruce Brian Fast, Whitehorse (CA)

Correspondence Address: Bruce Brian Fast, Suite 12, 4078 4th Ave., Whitehorse, YT, Y1A 4K8, CA

(21) Appl. No.: 10/384,034

(22) Filed: Mar. 10, 2003

Related U.S. Application Data
(60) Provisional application No. 60/383,930, filed on May 30, 2002.

(51) Int. Cl. G06K 1/00; G06F 15/00

(52) U.S. Cl. 358/1.18; 358/3.28

(57) ABSTRACT

A process for validating groups of machine-read data fields in electronic images of documents with the steps of: A group of data fields, each containing an image, at least one perceived value, A relationship relating each field to the others, A of establishing whether the relationship is met, and of calculating a perceived value which fulfills the relationship, A of presenting the image, one of the perceived values and the calculated value for each of the fields to a human operator., A of allowing the human operator to edit one of the percieved values, and A of allowing the human operator to select one of the calculated values as being correct.

### CROSS REFERENCE TO RELATED APPLICATIONS

This application is based on U.S. provisional application serial No. 60-383930, filed on May 30, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of document imaging and more specifically to a process for validating groups of machine-read data fields in images of documents.

Since the introduction of machine-reading (Optical Character Recognition and Intelligent Character Recognition), it has been obvious that such technology would not be able to interpret images of letters with anything near perfect reliability. While leaps have been made in these technologies, the results are still inadequate for many forms processing situations without human intervention.

Virtually all commercially available OCR technologies and forms processing technologies have a validation tool. These tools normally expect the OCR engine to report it's ‘level of confidence’ that it has correctly read a particular word or letter. (Most often validation is presented on a letter by letter basis.) Validation tools usually permit the user to establish levels of confidence to obtain a balance between the number of errors that filter through, and the amount of correct reads that the operator must confirm.

A second technological solution, commonly referred to as ‘voting’ has been developed to reduce the number of required interventions, and to obtain a second opinion as to the level of uncertainty. This technology uses three or more OCR technologies from different suppliers to read the same text. If the results of the separate OCR technologies agree on a value, it is assumed to be correct, if at least half of the engines aggree, the results are usually considered to be correct, if they all dissaggree, human intervention is called for.

In the real world, simple validation tools which count on OCR confidence levels to request validations produce an extensive number of validations where the OCR engine was correct in the first place. If the confidence threshold is set low enough to reduce the number of such unnessasary validations, the number of errors which are passed through is surprisingly high. Even if the confidence threshold is set high, errors are passed through because the OCR technology is often confident even when it is in error.

The more advanced ‘voting’ technology is a significant improvement, however, it proves to only be an improvement of degree. Validations where one of the OCR engines was correct after all are still high, and the number of times that errors filter through is still often too high for many data processing situations. Further, by requiring at least three, and usually five, separate OCR processes, the method is expensive, and slow.

Accountants have been using crosschecks for years, adding up columns and expecting the values to equate to a total. The results are radically reduced error rates. Most paper forms containing data, especially when the data they contain is of significant importance, contain these crosscheck methods. Frequently these methods involve simple mathematical formulas—all the values in this column should add up to the value in the total field, for instance. However, often there are other methods for establishing crosscheck relationships between data fields. A user name, and an account number may both exist in a database. If a search of the database by user name can produce the account number, or if a search by account number can produce the user's name, then a non-mathematical relationship exists between the two fields. If a search of the database by a form's OCR read name produces the OCR read account number then chances are very good that both the name and account number are correct.

### BRIEF SUMMARY OF THE INVENTION

The primary object of the invention is To reduce the number of human interventions required to obtain high quality data from machine read forms.

Another object of the invention is To improve the quality of data output in machine-read forms.

Another object of the invention is To validate machine-read output in groups of related fields.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for validating groups of machine-read data fields in images of documents comprising the steps of: A group of data fields, each containing an image, at least one perceived value, A relationship relating each field to the others, A means of establishing whether the relationship is met, and of calculating a perceived value which fulfills the relationship, A means of presenting said image, one of said perceived values and said calculated value for each of said fields to a human operator. , A means of allowing the human operator to edit one of said percieved values, and A means of allowing the human operator to select one of said calculated values as being correct..

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the operations that comprise the method.

FIG. 2 is a chart detailing the mathematical relationships between set of example fields

FIG. 3 is an image of a set of example fields rendered for human input.

FIG. 4 is a chart detialing the mathematical calculations performed when fields have multiple perceived values.

FIG. 5 is a chart detailing an example database used for an example database comparison relationship

FIG. 6 is an image of a set of example fields which have a database comparison relationship, rendered for human input.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is common in with forms processing technologies to locate areas on an electronic image of a document to locate and designate these to be data fields. These data fields are then communicated to OCR technologies, or human ‘key from image’ operators, who establish an electronically readable value for same. These technologies do not produce sufficiently accurate results in many instances. Methods of confirming the accuracy of results are common, however to my knowledge there has not been established systems of confirming the accuracy of multiple fields at once.

I will now present the details of how I have implemented an ability to compare the perceived values of multiple related fields. This technique assures an extremely low error rate in the process of converting images of structured documents such as forms into computer manipulable data while reducing the number of human interventions required to produce the same.

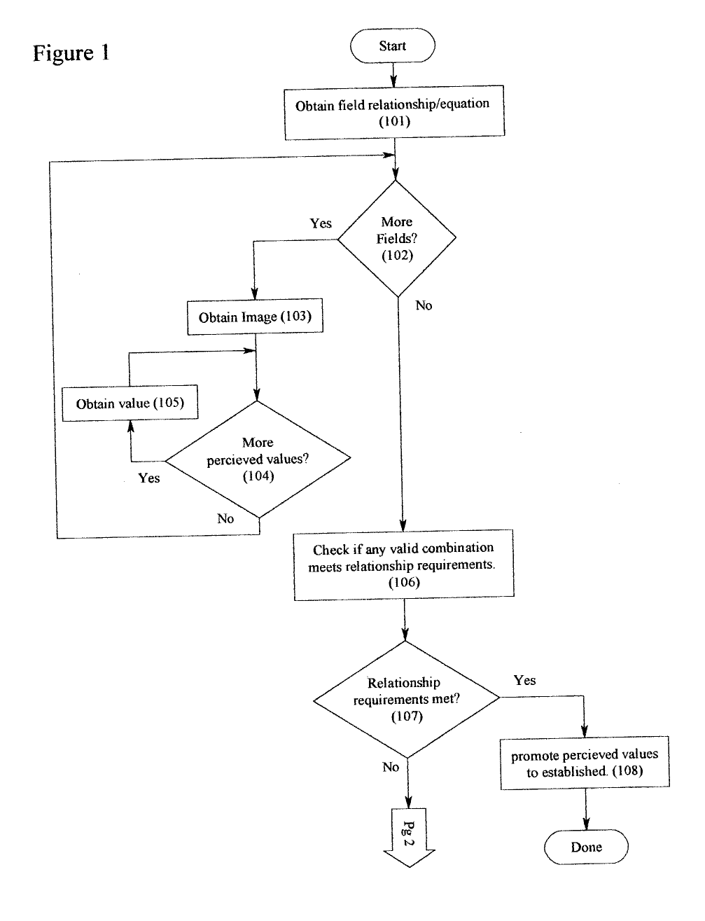

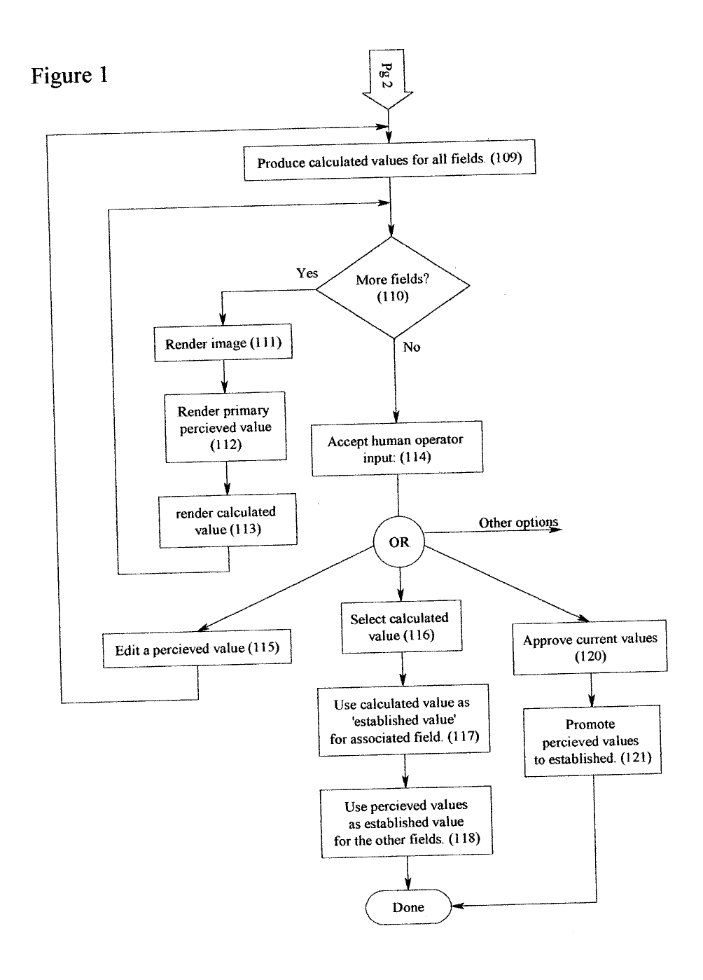

Please consider Flowchart FIG. 1.

I presume that a relationship or relationship equation defining the relationship between a group of fields has been established (101).

I presume that at least one perceived value (104) has been established for each field in said group.

Now, the most common means of establishing a perceived value is to pass the relevant image to OCR (Optical Character Recognition) technology. To obtain multiple perceived values, one may pass said relevant image past multiple OCR technologies. Other methods of obtaining perceived values include passing said image to a human ‘key from image’ operator, or extrapolating based upon ‘second choice’ reports from said OCR technology or based upon common OCR errors. (For instance, when number have leading $, it is common for an OCR to read the leading $ as a 5. If this is an issue, every time said OCR produces a value with a leading 5, such as 534.95, one may also consider the value 34.95 as an alternate perceived value.)

Because the purpose of this technology is to establish correct values in a conversion from image to digital values, I presume that for each field in said group of fields, an image exists which is the authorized source for said field. This is commonly represented as a file containing a compressed image, and the dimensions of a bounding box where the image of said field is located within said full image.

Initially, I gather the relevant data for said group of fields. I obtain said relationship information for said group of fields (101). For each field in the group I obtain all perceived values and I obtain the appropriate image, as per (102)-(105). (Note, I may actually do the computational check (106) prior to locating said images because if the perceived values correlate to said field relationship, said images will not be used.

Doing said computational check is slightly different if said field relationship is a field relationship equation (mathematical) or a non-mathematical field relationship.

Mathematical relationships are represented with a mathematical operation assigned to relate each field to the field greater than it. So a mathematical operation is assigned for the relationship between field 1 and field 2 of a group, and between field 2 and field 3 of said group. A mathematical relationship must have a mathematical operation ‘equals’ relating two fields. Therefore valid mathematical relationships would include: f1+f2+f3=f4, or f1*f2=f3+f4. (It would be reasonable to have mathematical constants in said mathematical relationship, such as f1+f2+f3+f4=243.95, though such mathematical constants are not considered for all future discussions in this document.)

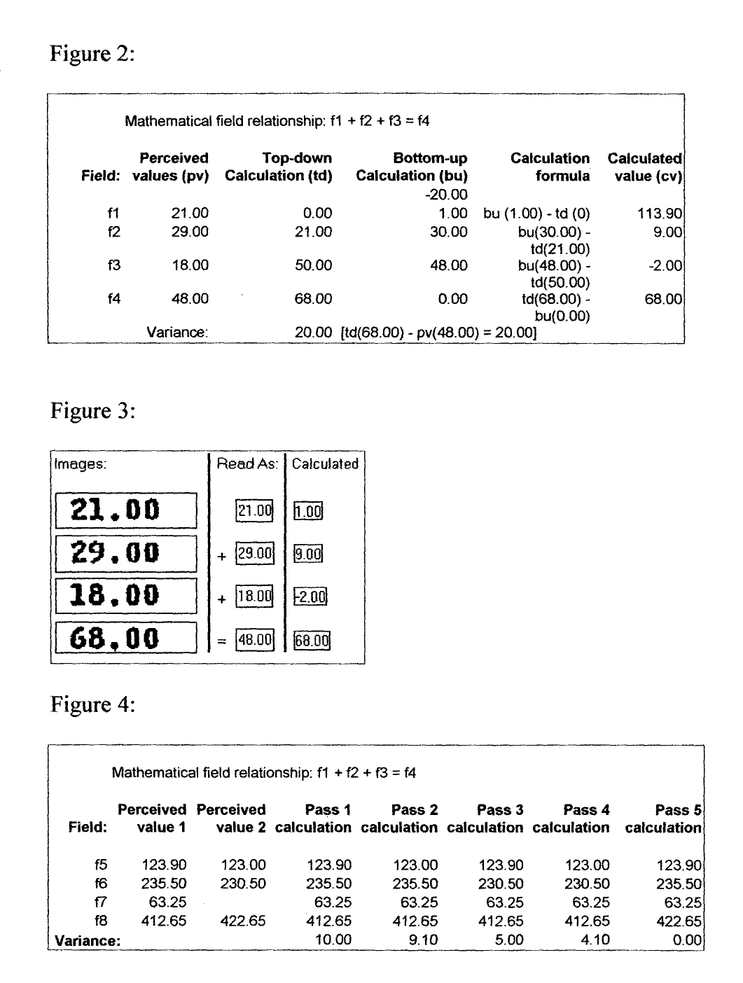

Determining if a correlation exists for said group of fields, where said relationship information is in the form of a mathematical relationship, is quite straightforward. Apply the mathematical formula. If the results correlate then the perceived values have been validated. I then report each of said perceived values as ‘established’ (108). In this case, all perceived values in said group of fields have been confirmed without any human intervention. (See FIG. 2: Variance. In this case a variance of 20.00 indicates that said correlation does not exist.)

In FIG. 4, I consider the instance where we have multiple perceived values for some of the fields in a group of fields. In this case I repeatedly apply said mathematical relationship selecting a unique pattern of one perceived value from each field in said group until either said mathematical relationship produces a correlation, or until all such unique patterns have been searched. In FIG. 4, step 1, I present using perceived value 1 for all fields f5 through 58 as my values when I apply said mathematical formula. The resultant variance is 10.00. As it is not 0, I continue my analysis. Pass 2 considers value 2 for field f5, and value 1 for all other fields in said group of fields. This produces a variance of 9.10, again not producing a result. I then consider value 2 for field f6, and value 1 for all other fields in said group. The resulting variance is 5.00. I continue this pattern of: for each value in the first field of the group, for each value in the second field of the group . . . for each value in the nth field of the group—apply said mathematical formula. If the resultant variance is not 0, continue.

In the example of FIG. 4, we see that a comparison of value 2 for field f8 with value 1 for all other fields in said group produces a variance of 0. When such a result is achieved, the values which were used to produce a 0 variance condition are promoted as ‘established’, and the analysis of said group is completed (108). Again, no human intervention is involved in establishing confirmed values for all fields of said group.

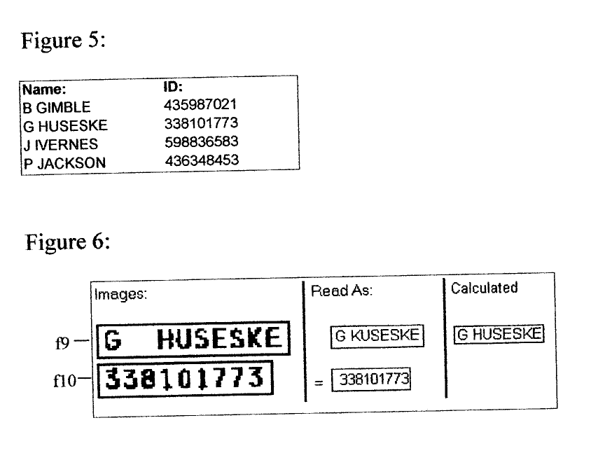

If said field relationship of step (106) is not mathematical, there must be some other way of checking whether any field correlates with ‘the other fields’ in said field group. (In FIGS. 5 and 6, I present the example of a name field and an id field that are correlated by a database lookup. In this example, the perceived value for said name is in error. When I attempt to look the field up in the database of FIG. 6, I get no result. Because of this, the calculated result for field f10 of FIG. 6 is left blank—there is no suggested alternate value determined by logic. However, a calculated value for field f9, a value of “G HUSESKE” is presented because when we look up the value of field f10 in said database, we see that such value exists in said database, and has an associated name of “G HUSESKE”. Therefore, if field f10 were to read “G HUSESKE” it would correctly relate to the value of field f9. This is how step (109) is fulfilled in this non-mathematical case.

A note with regarding situations such as exemplified in FIGS. 5 and 6. “G KUSESKE” is very similar to “G HUSESKE”. In this case there is only one letter of difference between the two. It is often reasonable, as it likely would be in this example, to use a less precise ‘fuzzy’ comparison such that if said ID field can be found in the database, and said name field is sufficiently ‘like’ said database name field associated with said ID, we can assume that there is a minor error in the perceived value for said field f10, and we can use said database name field as the ‘established value’ for said field f10. Likewise if a name field were to be located in the database, and said database entry contained a ID value that was sufficiently similar to the perceived ID associated with said name field, then said database ID value could be accepted as the ‘established value’. Note that in this case ‘sufficiently’ is defined by calculating the cost of having an error compared to the cost of human operators having to validate more fields. Again, we see that this technology allows for completely automated correction and confirmation that perceived results are correct without human intervention.

At this point, in real world image processing, by far the majority of fields presented will have been assigned established values without any human intervention. However, this approach also significantly reduces the complexity of the human interventions that are required compared to the established validation technologies.

Before presenting a group of fields on a display device to a human operator, ‘calculated perceived values’ must be established for each field (109). (Though it may be impossible to calculate a perceived value for a particular field as exemplified below.)

I now return to FIG. 2 to consider how the calculated perceived value is produced (109) for said mathematical relationship case.

I establish a primary perceived value (pv) for each field in the group. If there are multiple perceived values for a field, one of those fields is chosen as the primary perceived value. (Often one of those fields is considered the ‘most likely to be correct’, such as the results from the most effective OCR tool. In other cases a field is chosen at random.)

Initially I create a table which I have labeled “Top-down calculation” or (td). This calculation is performed as follows: I work through each field in the group in forward order. For the first field of said group, I enter a value of 0. The second field of the group is assigned the perceived value pv[1]. For subsequent fields, in (td), the value of (td)[n] is (td)[n−1] <mathematical relationship between f[n−1] and f[n]> pv[n]. So if to establish the third entry in table (td), I recognize that the relationship between f2 and f3 is a “+” relationship, I recognize that the second entry in (td), (td)[2] is 21.00, and that the perceived value of f2 (pv[3−1]) is 29.00. So (td)3]=(td)[2]+pv[2]. (td)[3]=21.00 +29.00 =50.00.

As we work through the formula, when the = is encountered, we use the complement of the mathematical formula, so a “+” will be treated as a “−” and a “*” will be treated as a “/”. The equals itself will now be treated as a “−”. We continue this calculation until (td)[n+1] is calculated where n is the number of fields in said group of fields. In FIG. 2 we see (td)[n+1] calculated as follows:

In this example there are 4 fields, therefore n is 4.

(td)[n] is 68.00

pv[n] is 48.00

The relationship between f3 and f4 is equals, so “−” is used.

(td)[n+1]=(td)[n]−pv[n]=68.00−48.00=20.00

(td)[n+1] is the variance. If this value were 0, then the mathematical relationship would correlate.

Calculating a second table “bottom up” (bu) is done similarly to the calculation of (td) above. However, this time, I work from the last field to the first. If one were to reverse the order of the fields, do the calculations into (bu) as per (td), then reverse the order of table (bu), and set the first entry of (bu) (the entry that was (bu)[n+1] prior to inverting) as (bu)[0], one would get the desired results.

Once tables (td) and (bu) are calculated, obtaining the calculated value (cv) for each field is quite straightforward. For each field n in said group of fields, if the field preceeds the ‘equals’ field (in said example, field f4), cv[n]=bu[n] <inverse function> td[n]. (Where inverse function is complement of the mathematical formula relating field n with the previous field, the mathematical formula for the first field being treated as a “+”, and the mathematical formula for = being treated as a “+”)

After the equals, the formula becomes cv[n]=td[n] <function> bu[n].

The results of this math, for this condition where the field relationship is a mathematical relationship is that calculated values (cv) are the values which, for each field n, if (pv)[n] were (cv)[n] then the mathematical relationship would correlate.

Note that it is the nature of math that a calculated value may not exist. For instance, if a group had three fields (g1, g2 and g3) with a mathematical relationship g1*g2=g3, (pv)[1]=123, (pv)[2]=0, (pv)[3]=1. We would not be able to establish a calculated value (cv)[1] because no value*0=1.

At this point, I have established three things:

I have established that an automated method of producing an ‘established value’ is not available.

I have located all information necessary to present said group of fields to a human operator.

I have established ‘calculated values’ for each field in said group where such calculated values exist.

It is now time to present the information on a display device capable of rendering images, to the human operator.

In FIG. 3 I present the data of FIG. 2. For each field in said group of fields, I render said image (111), I render said perceived value (112), and I render said calculated value (113). (Note also that I render said formula.)

Now, I render the perceived values in an editable text field. The human operator can simply choose to edit a particular perceived value (115). Changes made to any perceived value produces new calculated values for said entire group of fields.

In the vast majority of cases one of said calculated perceived values is the correct value. Usually said other calculated values are very clearly in error. I render said calculated perceived values on said display device in a selectable field—a display field that the operator may choose, usually by clicking with a mouse. To complete the validation process, all a human operator must do is select the correct calculated perceived value (116). When this is done, for the field whose calculated value was chosen, said calculated value is used as the ‘established value’ (117). For all other fields in said group of fields, their ‘perceived values’ (118) are used as their ‘established values’.

I usually present an option which declares all values to be correct even if they do not correctly calculate (120). I also may present other options to the human operator.

This concept of using logical crosschecks has been used by the accounting world for many years to reduce errors. It is certainly an effective way of reducing errors. In this context, provides the low error rates that accounting is used to, it also proves to be an effective method of reducing both the number and complexity human interventions in the process of assuring correct data.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for establishing the accuracy of perceived values for data fields in images of documents by:
A. providing a plurality of data fields each of said fields containing a related authorized image, and each of said fields containing one perceived value,
B. providing a relationship that correlates the value of each of said fields to the others,
C. providing a display device capable of rendering images, and editable text fields to a human operator and capable of responding to human operator feedback,
D. a step for checking to see if said perceived value in each of said fields fulfills said relationship and for establishing that said perceived values are correct, and if said relationship is not fulfilled:
F. A step for rendering said related authorized image, and said perceived value for each of said fields on said display device,
G. A step for responding to human operator editing of any of said perceived values, and for confirming that said edited percieved values are correct.
Whereby a the accuracy of perceived values for a group of related fields can often be established without human intervention and whereby the entire group of related fields can be presented to a human operator for corrections to any fields within the group.

2. The features of claim 1 wherin:
A. said display device also is capable of rendering selectable fields,
B. a step for generating a calculated perceived value for each of said fields wherein said calculated perceived value fulfills the requirements of said relationship if said perceived value is used as the established value for said field and said perceived values are used for all other fields, wherein such value can be established, implemented prior to said step for rendering said related authorized image,
C. said step for rendering said related authorized image including a rendering of said calculated perceived value for each of said fields.
D. A further step for responding to human operator editing of any of said perceived values by recalculating all of said calculated perceived values, and re-rendering said new calculated perceived values,
E. A step for responding to human operator selection of one of said calculated perceived values by establishing said selected calculated perceived values as correct, and establishing said perceived values for each of said fields other than said field which was associated with said calculated perceived value as correct.
Whereby a mechanism is established which frequently provides a human operator the ability to establish the correct values for said entire group of fields with the minimal effort of a single selection.

3. The features of claim 1 wherein said step for providing a relationship that correlates the values of each of said fields is further defined as a linear mathematical relationship wherein said relationship contains one of an equals, or an implied equating to 0.

4. The features of claim 1 wherein said step of providing a relationship that correlates the values of each of said fields is further defined as a searchable crossreference table which relates the fields.

5. A process for establishing the accuracy of perceived values for data fields in images of documents by:
A. providing a plurality of data fields each of said fields containing a related authorized image, and each of said fields containing at least one perceived value,
B. providing a relationship that correlates the value of each of said fields to the others,
C. providing a display device capable of rendering images, and editable text fields to a human operator and capable of responding to human operator feedback,
D. a step for checking to see if any combination of said perceived values in each of said fields fulfills said relationship and for establishing that said combination of perceived values are correct, and if said relationship is not fulfilled:
F. A step for rendering said related authorized image, and one of said perceived values for each of said fields on said display device,
G. A step for responding to human operator editing of any of said perceived values, and for confirming that said edited percieved values are correct.
Whereby a the correct combination of multiple perceived values for a group of related fields can often be established without human intervention and whereby the entire group of related fields can be presented to a human operator for corrections to any fields within the group.

6. The features of claim 5 wherin:
A. said display device also is capable of rendering selectable fields,
B. a step for generating a calculated perceived value for each of said fields wherein said calculated perceived value fulfills the requirements of said relationship if said perceived value is used as the established value for said field and said perceived values are used for all other fields, wherein such value can be established, implemented prior to said step for rendering said related authorized image,
C. said step for rendering said related authorized image including a rendering of said calculated perceived value for each of said fields.
D. A further step for responding to human operator editing of any of said perceived values by recalculating all of said calculated perceived values, and re-rendering said new calculated perceived values,
E. A step for responding to human operator selection of one of said calculated perceived values by establishing said selected calculated perceived values as correct, and establishing said perceived values for each of said fields other than said field which was associated with said calculated perceived value as correct.
Whereby a mechanism is established which frequently provides a human operator the ability to establish the correct values for said entire group of fields with the minimal effort of a single selection.

7. The features of claim 5 wherein said step for providing a relationship that correlates the values of each of said fields is further defined as a linear mathematical relationship wherein said relationship contains one of an equals, or an implied equating to 0.

8. The features of claim 5 wherein said step of providing a relationship that correlates the values of each of said fields is further defined as a searchable crossreference table which relates the fields.
